(19) United States
(12) Patent Application Publication
(10) Pub. No.: US 2024/0336714 A1
(43) Pub. Date: Oct. 10, 2024

(54) POLYETHYLENE COPOLYMER FOR A FILM LAYER

(71) Applicant: BOREALIS AG, Vienna (AT)

(72) Inventors: Jingbo WANG, Linz (AT); Friedrich BERGER, Linz (AT); Jani AHO, Porvoo (FI); Juulia HIRVONEN, Kulloo (FI); Andreas ALBRECHT, Linz (AT)

(73) Assignee: BOREALIS AG, Vienna (AT)

(21) Appl. No.: 18/293,939

(22) PCT Filed: Aug. 4, 2022
(86) PCT No.: PCT/EP2022/071893

§ 371 Date: Jan. 31, 2024

(30) Foreign Application Priority Data
Aug. 6, 2021 (EP) 21190018.8

(51) Int. Cl. C08F 210/16; C08F 4/659; C08F 4/6592; C08J 5/18; C08L 23/08

(52) U.S. Cl. CPC C08F 210/16; C08F 4/65912; C08F 4/65916; C08F 4/65927; C08J 5/18; C08L 23/0815; C08J 2323/08; C08L 2203/16; C08L 2205/025; C08L 2205/03; C08L 2207/066; C08L 2314/06

(57) ABSTRACT

The present disclosure relates to a metallocene-catalysed multimodal polyethylene copolymer, to the use of the multimodal copolymer of ethylene in film applications and to a film including the polymer composition.

The present invention relates to a metallocene-catalysed multimodal polyethylene copolymer (P), to the use of the multimodal polyethylene copolymer (P) in film applications and to a film comprising the polymer composition of the invention.

State of the art mLLDPE (metallocene catalysed linear low density polyethylene) is widely used everywhere in daily life, like packaging, due to its excellent cost/performance ratios. One of the famous drawback is the narrow molecular weight distribution and therefore less shear thinning, which leads to the problem in film conversion, e.g. limiting the throughput. In addition, higher throughputs in the plastic processing industry are further limited by melt flow instabilities, which change the appearance and properties of the final product and have economic and also environmental consequences. One important parameter here is the critical shear rate [s⁻¹] (CSR) at which the melt flow instability starts.

Processing instabilities are i.a. influenced by the molecular structure of the polymer and presence of special additives.

It is desirable, if the critical shear rate (CSR) is as high as possible, in order to improve the processing of the polymer melt.

One common solution for improving the processability of a polymer melt is the addition of so-called processing aids. Unfortunately, the majority of suitable processing aids are fluoro-based polymers, which are due to their fluoro content under concerns in view of human and environmental health.

As mentioned above, the processability is also influenced by the molecular structure. Multimodal PE polymers with two or more different polymer components are known to be better to process, but e.g. melt homogenisation of the multimodal PE may be problematic resulting to inhomogeneous final product evidenced e.g. with high gel content of the final product.

Multimodal PE polymers are known in the art.

WO 2021009189, WO 2021009190 and WO 2021009191 of Borealis disclose a process for preparing multimodal PE polymers in two loop reactors and one gas phase reactor in the presence of a silica supported metallocene catalyst based on the metallocene complex bis (1-methyl-3-n-butylcyclopentadienyl) zirconium (IV) dichloride.

The polymers produced in the Examples have a total density of 938 or 939 kg/m3. The MFR2 (190° C., 2.16 kg, ISO 1133) of the polymer components produced in the first loop reactor is about 22 or 23 g/10 min. The MFR₂ (190° C., 2.16 kg, ISO 1133) of the polymer components after the second loop reactor not more than 31 g/10 min.

Film properties, like tensile modulus (TM) and impact strength in the Instrumented Puncture Test (IPT) or processing parameters, like the critical shear rate are not mentioned at all. Also WO 2021009192 discloses such a process. The polymer produced in the Examples has an even higher density of 951 kg/m³. The MFR₂ (190° C., 2.16 kg, ISO 1133) of the polymer component produced in the first loop is 32 g/10 min. The MFR₂ (190° C., 2.16 kg, ISO 1133) of the polymer components after the second loop reactor not more than 22 g/10 min.

Film properties, like tensile modulus (TM) and impact strength in the Instrumented Puncture Test (IPT) or processing parameters, like the critical shear rate are not mentioned at all.

It is desirable to maximise the processability of multimodal PE polymers, which have an improved melt flow stability expressed by a high critical shear rate (CSR). It goes without saying that any manipulation of the polymer properties to enable improved processability should not be detrimental to the final film properties.

Such multimodal PE polymers should furthermore have a low ratio of soluble fraction related (determined with crossfractionation chromatography (CFC)) to density, since this soluble fraction is typically problematic in certain packaging areas, e.g. in food packaging. Furthermore it is desirable, if all these improvements can be achieved without the addition of a processing aid.

The inventors have now found that a metallocene-catalysed multimodal polyethylene copolymer (P) made with a specific metallocene catalyst and having a specific polymer design has an improved processability, which can be seen in terms of higher possible critical shear rate (CSR).

Such a metallocene-catalysed multimodal polyethylene copolymer (P) has in addition a very low ratio of soluble fraction related (determined with crossfractionation chromatography (CFC)) to density.

The films made from such a metallocene-catalysed multimodal polyethylene copolymer (P) have in addition an improved balance of properties, especially in view of stiffness (i.e. tensile modulus) and impact properties, such as in the Instrumented Puncture Test (IPT).

### DESCRIPTION OF THE INVENTION

The present invention is therefore directed to a metallocene-catalysed multimodal polyethylene copolymer (P), which consists of
(i) 35.0 to 50.0 wt % of an ethylene-1-butene polymer component (A), and
(ii) 50.0 to 65.0 wt % of an ethylene-1-hexene polymer component (B),
   whereby the ethylene-1-butene polymer component (A) has
a density in the range of from 930 to 960 kg/m³,
an MFR₂ (190° C., 2.16 kg, ISO 1133) in the range of from 30.0 to 300.0 g/10 min,
a 1-butene content in the range of 0.1 to 3.0 mol %, based on the ethylene-1-butene polymer component (A);
wherein ethylene-1-butene polymer component (A) consists of an ethylene-1-butene
polymer fraction (A-1) and an ethylene-1-butene polymer fraction (A-2), the ethylene-1-hexene polymer component (B) has
a density in the range of from 880 to 920 kg/m³,
an MFR₂ (190° C., 2.16 kg, ISO 1133) in the range of from 0.001 to 1.0 g/10 min
a 1-hexene content in the range of 2.5 to 10.0 mol % based on the ethylene-1-hexene polymer compound (B);
   whereby the multimodal polyethylene copolymer (P) has
a density in the range of from 910 to 945 kg/m³,
an MFR₂ (190° C., 2.16 kg, ISO 1133) in the range of from 0.1 to 3.0 g/10 min,
a ratio of the molecular weight (Mw) of the low crystalline fraction (LCF) to the molecular weight (Mw) of the high crystalline fraction (HCF), Mw(Tp(LCF)/Mw(Tp(HCF), determined as described in the experimental part, in the range of from 2.5 to 10.0, a ratio of the breadth at Half peak height Tp(LCF)/to the breadth at Half peak height Tp(HCF) in the range of from 0.9-5.9 and
a ratio of the soluble fraction at 35° C. determined with crossfractionation chromatography (CFC) as described in the experimental part to the density of the multimodal polyethylene copolymer (P), SF@35° C./density_{P} of below 0.007.

In an embodiment of the present invention, the ethylene-1-butene polymer component (A) of the metallocene-catalysed multimodal polyethylene copolymer (P) consists of an ethylene polymer fraction (A-1) and an ethylene polymer fraction (A-2), wherein the density of fractions (A-1) and (A-2) is in the range of from 925 to 960 kg/m³ and the MFR₂ (190° C., 2.16 kg, ISO 1133) is in the range of from 30 to 300 g/10 min and wherein the density and/or the MFR₂ (190° C., 2.16 kg, ISO 1133) of ethylene polymer fractions (A-1) and (A-2) may be the same or may be different.

Unexpectedly the multimodal polyethylene copolymer (P) of the invention provides improved mechanical properties to films such as high impact strength in the Instrumented Puncture Test (IPT) and at the same time good tensile modulus.

The present invention is further directed to a film comprising the multimodal polyethylene copolymer (P) and to the use of this film.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed multimodal polyethylene copolymer is defined in this invention as multimodal polyethylene copolymer (P), which has been produced in the presence of a metallocene catalyst.

Term “multimodal” in context of multimodal polyethylene copolymer (P) means herein multimodality with respect to melt flow rate (MFR) of the ethylene polymer components (A) and (B), i.e. the ethylene polymer components (A) and (B) have different MFR values. The multimodal polyethylene copolymer (P) can have further multimodality with respect to one or more further properties between the ethylene polymer components (A) and (B), as will be described later below.

The multimodal polyethylene copolymer (P) of the invention as defined above, below or in claims is also referred herein shortly as “multimodal PE” or “multimodal copolymer (P)”.

The following preferable embodiments, properties and subgroups of multimodal PE and the ethylene polymer components (A) and (B) thereof, as well as the ethylene polymer fractions (A-1) and (A-2) and the film of the invention including the preferable ranges thereof, are independently generalisable so that they can be used in any order or combination to further define the preferable embodiments of the multimodal PE and the article of the invention.

### Multimodal PE as Well as Ethylene Polymer Component (A) and (B) and Ethylene Polymer Fractions (A-1) and (A-2)

The metallocene produced multimodal polyethylene copolymer (P) is referred herein as “multimodal”, since the ethylene-1-butene polymer component (A), including ethylene polymer fractions (A-1) and (A-2), and ethylene-1-hexene polymer component (B) have been produced under different polymerization conditions resulting in different Melt Flow Rates (MFR, e.g. MFR₂). I.e. the multimodal PE is multimodal at least with respect to difference in MFR₂ of the ethylene polymer components (A) and (B).

The metallocene produced multimodal polyethylene copolymer (P) consists of
(i) 35.0 to 50.0 wt % of an ethylene-1-butene polymer component (A), and
(ii) 50.0 to 65.0 wt % of an ethylene-1-hexene polymer component (B). The amount of (A) and (B) add up to 100.0 wt %.

The ethylene-1-butene polymer component (A) consists of an ethylene polymer fraction (A-1) and (A-2).

The MFR₂ of the ethylene polymer fractions (A-1) and (A-2) may be different from each other or may be the same.

The ethylene polymer fractions (A-1) and (A-2) have an MFR₂ (190° C., 2.16 kg, ISO 1133) in the range of 30.0 to 300.0 g/10 min, preferably of 35.0 to 250.0 g/10 min, more preferably of 40.0 to 200.0 g/10 min, even more preferably of 45 to 150.0 g/10 min.

The MFR₂ of the ethylene polymer components (A) and (B) are different from each other. The ethylene polymer component (A) has an MFR₂ (190° C., 2.16 kg, ISO 1133) in the range of 30.0 to 300 g/10 min, preferably of 35.0 to 250.0 g/10 min, more preferably of 40.0 to 200.0 g/10 min, even more preferably of 45 to 150.0 g/10 min.

The ethylene polymer component (B) has an MFR₂ (190° C., 2.16 kg, ISO 1133) in the range of 0.001 to 1.0 g/10 min, preferably of 0.005 to 0.9 g/10 min, more preferably of 0.008 to 0.7 g/10 min and even more preferably of 0.01 to 0.5 g/10 min.

The MFR₂ (190° C., 2.16 kg, ISO 1133) of the multimodal copolymer (P) is in the range of 0.1 to 3.0 g/10 min, preferably 0.2 to 2.5 g/10 min, more preferably 0.3 to 2.0 g/10 min and even more preferably 0.4 to 1.5.

Naturally, in addition to multimodality with respect to, i.e. difference between, the MFR₂ of ethylene polymer components (A) and (B), the multimodal PE of the invention can also be multimodal e.g. with respect to one or both of the two further properties: multimodality with respect to, i.e. difference between,
the comonomer content(s) present in the ethylene polymer components (A) and (B); and/or
the density of the ethylene polymer components (A) and (B).

Preferably, the multimodal copolymer (P) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (mol %) in component B=(comonomer content (mol %) in final product
(weight fraction of component A * comonomer content (mol %) in component A))/(weight fraction of component B)

The total amount of 1-butene, based on the multimodal polymer (P) is preferably in the range of from 0.1 to 1.0 mol %, preferably 0.2 to 0.8 mol % and more preferably 0.3 to 0.7 mol %.

The total amount of 1-hexene, based on the multimodal polymer (P) preferably is in the range of 1.5 to 8.0 mol %, preferably 2.0 to 6.0 mol % and more preferably 2.2 to 4.0 mol %.

The total amount (mol %) of 1-butene, present in the ethylene-1-butene polymer component (A) is of 0.1 to 3.0 mol %, preferably of 0.5 to 2.6 mol %, more preferably of 0.8 to 2.0 mol %, even more preferably of 1.0 to 1.8 mol %, based on the ethylene-1-butene polymer component (A).

The total amount (mol %) of 1-hexene, present in the ethylene-1-hexene polymer component (B) is of 2.5 to 10.0 mol %, preferably of 3.0 to 8.0 mol %, more preferably of 3.5 to 6.0 mol %, based on the ethylene-1-hexene polymer component (B).

Even more preferably the multimodal polymer (P) of the invention is further multimodal with respect to difference in density between the ethylene polymer component (A) and ethylene polymer component (B). Preferably, the density of ethylene polymer component (A) is different, preferably higher, than the density of the ethylene polymer component (B). The density of the ethylene polymer component (A) is in the range of 930 to 960 kg/m³, preferably of 935 to 955 kg/m³, more preferably 938 to 950 kg/m³ and/or the density of the ethylene polymer component (B) is of in the range of 880 to 920 kg/m³, preferably of 885 to 915 kg/m³ and more preferably of 890 to 910 kg/m³.

The polymer fractions (A-1) and (A-2) have a density in the range of from 925 to 960 kg/m³, preferably of 928 to 955 kg/m³, more preferably of 930 to 950 kg/m³, and most preferred 935 to 945 kg/m³.

The density of polymer fraction (A-1) and (A-2) may be the same or may be different from each other.

The metallocene catalysed multimodal copolymer (P) is preferably a linear low density polyethylene (LLDPE) which has a well known meaning.

The density of the multimodal copolymer (P) is in the range of 910 to 945 kg/m³, preferably of 912.0 to 925 kg/m³ and more preferably of 913.0 to 920.0 kg/m³.

More preferably the multimodal copolymer (P) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

The multimodal copolymer (P) furthermore may have a molecular weight distribution (Mw/Mn) determined with GPC in the range of at least 4.6 up to 7.2, preferably in the range of 5.0 to 7.0 and more preferably in the range of 5.5 to 6.8.

In addition, the multimodal copolymer (P) has a ratio of the molecular weight (Mw) of the low crystalline fraction (LCF) to the molecular weight (Mw) of the high crystalline fraction (HCF), Mw(Tp(LCF)/Mw(Tp(HCF), determined as described in the experimental part, in the range of from 2.5 to 10.0, preferably in the range of 3.0 to 8.0, and more preferably of 3.5 to 6.5.

Furthermore the multimodal copolymer (P) has a ratio of the breadth at Half peak height Tp (LCF)/to the breadth at Half peak height Tp (HCF) in the range of from 0.9-5.9, preferably 0.9 to 4.0, more preferably 1.0 to 2.0.

Definition of High crystalline fraction (HCF) and Low crystalline fraction (LCF): The high crystalline fraction (HCF) is the amount in wt % of the polymer fraction with a crystallisation temperature higher than 90° C., which mainly contains the homo-polyethylene chains or chains with a very low branching content.

The low crystalline fraction (LCF) is than the amount in wt % of the polymer fraction with a crystallisation temperature between 30 to below 90° C.

Furthermore the multimodal copolymer (P) has a ratio of the soluble fraction at 35° C. determined with crossfractionation chromatography (CFC) as described in the experimental part to the density of the multimodal polyethylene copolymer (P), SF@35° C./density_{P} of below 0.007, preferably below 0.006, more preferably below 0.005, like in the range of 0.001 to below 0.007, preferably 0.001 to below 0.006 and more preferably 0.001 to below 0.005.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 35.0 to 50.0 wt % based on the multimodal copolymer (P), preferably in an amount of 36.0 to 48.0 wt % and even more preferably in an amount of 38.0 to 45.0 wt %.

Thus, the ethylene polymer component (B) is present in an amount of 50.0 to 65.0 wt % based on the multimodal copolymer (P), preferably in an amount of 52.0 to 64.0 wt % and more preferably in an amount of 55.0 to 62.0 wt %.

The multimodal copolymer (P) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable metallocene catalysed multimodal copolymer (P) can be found in these references. A suitable process is the Borstar PE process or the Borstar PE 3G process.

The metallocene catalysed multimodal copolymer (P) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein. It is understood within the scope of the invention, that the amount or polymer produced in the prepolymerization lies within 1 to 5 wt % in respect to the final metallocene catalysed multimodal copolymer (P). This can counted as part of the first ethylene polymer component (A).

### Catalyst

The metallocene catalysed multimodal copolymer (P) used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

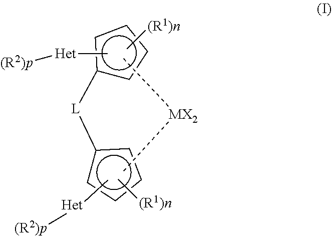

wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

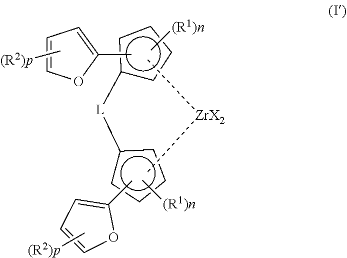

wherein each X is independently a halogen atom, a C₁₋₆-alkyl, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

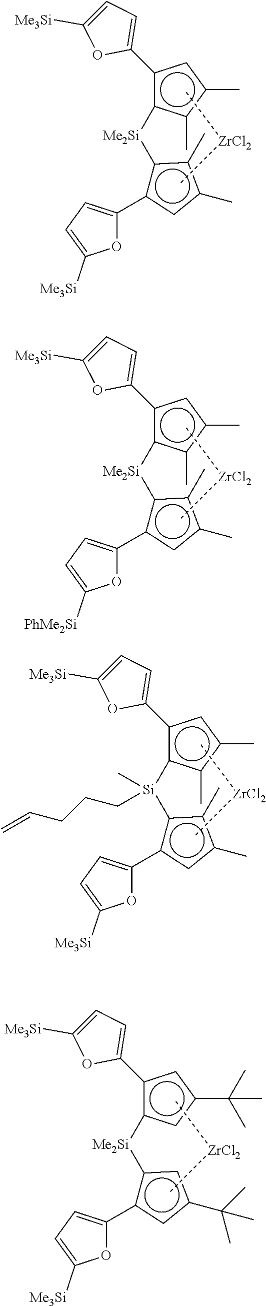

Most preferably the complex dimethylsilanediylbis [2-(5-trimethylsilylfuran-2-yl)-4,5-dimethylcyclopentadien-1-yl] zirconium dichloride is used.

More preferably the ethylene polymer components (A) and (B) of the multimodal copolymer (P) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred. Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The metallocene catalysed multimodal copolymer (P) may contain further polymer components and optionally additives and/or fillers. In case the metallocene catalysed multimodal copolymer (P) contains further polymer components, then the amount of the further polymer component(s) typically varies between 3.0 to 20.0 wt % based on the combined amount of the metallocene catalysed multimodal copolymer (P) and the other polymer component(s).

The optional additives and fillers and the used amounts thereof are conventional in the field of film applications. Examples of such additives are, among others, antioxidants, UV-stabilizers, pigments, fillers, antistatic additives, antiblock agents, nucleating agents and acid scavengers.

In an embodiment of the present invention the metallocene catalysed multimodal copolymer (P) does not contain any processing aid, especially does not contain any fluoro based polymer processing aid.

It is understood herein that any of the additives and/or fillers can optionally be added in so-called master batch, which comprises the respective additive(s) together with a carrier polymer. In such case the carrier polymer is not calculated to the polymer components of the metallocene catalysed multimodal copolymer (P), but to the amount of the respective additive(s), based on the total amount of polymer composition (100 wt %).

### Film of the Invention

The film of the invention comprises at least one layer comprising the metallocene catalysed multimodal copolymer (P). The film can be a monolayer film comprising the metallocene catalysed multimodal copolymer (P) or a multilayer film, wherein at least one layer comprises the metallocene catalysed multimodal copolymer (P). The terms “monolayer film” and multilayer film” have well known meanings in the art.

The layer of the monolayer or multilayer film of the invention may consist of the metallocene catalysed multimodal copolymer (P) as such or of a blend of the metallocene catalysed multimodal copolymer (P) together with further polymer(s). In case of blends, any further polymer is different from the metallocene catalysed multimodal copolymer (P) and is preferably a polyolefin. Part of the above mentioned additives can optionally added to the metallocene catalysed multimodal copolymer (P) during the film preparation process. Preferably, the at least one layer of the invention comprises at least 50 wt %, more preferably at least 60 wt %, even more preferably at least 70 wt %, yet more preferably at least 80 wt %, of the metallocene catalysed multimodal copolymer (P) of the invention. Most preferably said at least one layer of the film of invention consists of the metallocene catalysed multimodal copolymer (P).

Accordingly, the films of the present invention may comprise a single layer (i.e. monolayer) or may be multilayered. Multilayer films typically, and preferably, comprise at least 3 layers.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

The resulting films may have any thickness conventional in the art. The thickness of the film is not critical and depends on the end use. Thus, films may have a thickness of, for example, 300 μm or less, typically 6 to 200 μm, preferably 10 to 180 μm, e.g. 20 to 150 μm or 20 to 120 μm. If desired, the polymer of the invention enables thicknesses of less than 100 μm, e.g. less than 50 μm. Films of the invention with thickness even less than 20 μm can also be produced whilst maintaining good mechanical properties.

Furthermore, the present invention is also directed to the use of the inventive article as packing material, in particular as a packing material for food and/or medical products.

The films of the invention are characterized by an impact strength in the Instrumented Puncture Test (IPT) determined according to ISO 7765-2 on a 40 μm monolayer test blown film of at least 110 J/mm to 300 J/mm, preferably 115 J/mm to 250 J/mm and more preferably 120 J/mm to 200 J/mm.

Films according to the present invention furthermore have good stiffness (tensile modulus measured on a 40 μm monolayer test blown film according to ISO 527-3), i.e. >160 MPa (in both directions).

Thus, the films comprising the metallocene catalysed multimodal copolymer (P) may further have a tensile modulus (measured on a 40 μm monolayer test blown film according to ISO 527-3) in machine (MD) as well as in transverse (TD) direction in the range of from >160 MPa to 350 MPa, preferably of from 180 MPa to 300 MPa.

The specific design of the metallocene catalysed multimodal copolymer (P) of the invention makes the polymer very beneficial for making films. Benefits can be seen in excellent extrudability and especially in the clearly improved processability, which is possible by using the metallocene catalysed multimodal copolymer (P) of the invention in the film making machinery than corresponding film materials having the same level of density and MFR. The improved processability is expressed by a critical shear rate (CSR) determined according to ISO 11443 of at least 200 s⁻¹, preferably of at least 500 s⁻¹, and more preferably of at least 800 s⁻¹. A suitable upper limit of the critical shear rate (CSR) is 1500 s⁻¹, preferably 1300 s⁻¹.

The higher possible critical shear rate (CSR) is not achieved at the expense of good mechanical properties.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

$$\begin{matrix}Calculation of MFR2 of Component B and of Fraction & \\ & ( A - 2 )\end{matrix}$$

$$log A = x \cdot log B + ( 1 - x ) \cdot log C$$

$$C = 10 {\hat{}}^{\frac{( logA - x \cdot logB )}{( 1 - x )}}$$

For Component B:
B=MFR₂ of Component (A)
C=MFR₂ of Component (B)
A=final MFR₂ (mixture) of multimodal polyethylene copolymer (P)
X=weight fraction of Component (A)

For Fraction (A-2):
B=MFR₂ of 1st fraction (A-1)
C=MFR₂ of 2nd fraction (A-2)
A=final MFR₂ (mixture) of loop polymer (=Component (A))
X=weight fraction of the 1st fraction (A-1)

### Density

Density of the polymer was measured according to ASTM D792, Method B (density by balance at 23° C.) on compression moulded specimen prepared according to EN ISO 1872-2 and is given in kg/m³.

### Comonomer Contents

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimized 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilizing the NOE at short recycle delays of 3 s {pollard04, klimke06} and the RS-HEPT decoupling scheme {fillip05, griffin07}. A total of 1024 (1k) transients were acquired per spectra.

Quantitative ¹³C {¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = Btotal / ( Etotal + Btotal + Htotal )$$

The amount isolated 1-butene incorporated in EEBEE sequences was quantified using the integral of the *B2 sites at 39.8 ppm accounting for the number of reporting sites per comonomer:
B=I_{*B2}

If present the amount consecutively incorporated 1-butene in EEBBEE sequences was quantified using the integral of the ααB2B2 site at 39.4 ppm accounting for the number of reporting sites per comonomer:

$$BB = 2 * I αα B 2 B 2$$

If present the amount non consecutively incorporated 1-butene in EEBEBEE sequences was quantified using the integral of the ββB2B2 site at 24.6 ppm accounting for the number of reporting sites per comonomer:

$$BEB = 2 * I αα B 2 B 2$$

Due to the overlap of the *B2 and *βB2B2 sites of isolated (EEBEE) and non-consecutively incorporated (EEBEBEE) 1-butene respectively the total amount of isolated 1-butene incorporation is corrected based on the amount of non-consecutive 1-butene present:

$$B = {I}_{* B 2} - 2 * {I}_{β β B 2 B 2}$$

Sequences of BBB were not observed. The total 1-butene content was calculated based on the sum of isolated, consecutive and non consecutively incorporated 1-butene:

$$Btotal = B + BB + BEB$$

The total mole fraction of 1-butene in the polymer was then calculated as:

$$fB = Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = Htotal / ( Etotal + Btotal + Htotal )$$

The amount isolated 1-hexene incorporated in EEHEE sequences was quantified using the integral of the *B4 sites at 38.3 ppm accounting for the number of reporting sites per comonomer:
H=I_{*B4}

If present the amount consecutively incorporated 1-hexene in EEHHEE sequences was quantified using the integral of the ααB4B4 site at 40.5 ppm accounting for the number of reporting sites per comonomer:

$$HH = 2 * I αα B 4 B 4$$

If present the amount non consecutively incorporated 1-hexene in EEHEHEE sequences was quantified using the integral of the βαB4B4 site at 24.7 ppm accounting for the number of reporting sites per comonomer:

$$HEH = 2 * I ββ B 4 B 4$$

Sequences of HHH were not observed. The total 1-hexene content was calculated based on the sum of isolated, consecutive and non consecutively incorporated 1-hexene:

$$Htotal = H + HH + HEH$$

The total mole fraction of 1-hexene in the polymer was then calculated as:

$$fH = Htotal / ( Etotal + Btotal + Htotal )$$

The mole percent comonomer incorporation is calculated from the mole fraction:

$$B [ mol \% ] = 100 * fB$$

$$H [ mol \% ] = 100 * fH$$

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28.05 ) )$$

$$H [ wt \% ] = 100 * ( fH * 84.16 ) / ( ( fB * 56.11 ) + ( fH * 84.16 ) + ( ( 1 - ( fB + fH ) ) * 28.05 ) )$$

### REFERENCES

Klimke, K., Parkinson, M., Piel, C., Kaminsky, W., Spiess, H.W., Wilhelm, M., Macromol. Chem. Phys. 2006;207:382.
Parkinson, M., Klimke, K., Spiess, H. W., Wilhelm, M., Macromol. Chem. Phys. 2007;208:2128.
Pollard, M., Klimke, K., Graf, R., Spiess, H. W., Wilhelm, M., Sperber, O., Piel, C., Kaminsky, W., Macromolecules 2004;37:813.
Filip, X., Tripon, C., Filip, C., J. Mag. Resn. 2005, 176, 239
Griffin, J. M., Tripon, C., Samoson, A., Filip, C., and Brown, S. P., Mag. Res. in Chem. 2007 45, S1, S198
Castignolles, P., Graf, R., Parkinson, M., Wilhelm, M., Gaborieau, M., Polymer 50 (2009) 2373
Busico, V., Cipullo, R., Prog. Polym. Sci. 26 (2001) 443
Busico, V., Cipullo, R., Monaco, G., Vacatello, M., Segre, A. L., Macromoleucles 30 (1997) 6251
Zhou, Z., Kuemmerle, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Severn, J., Talarico, G., Macromol. Rapid Commun. 2007, 28, 1128
Resconi, L., Cavallo, L., Fait, A., Piemontesi, F., Chem. Rev. 2000, 100, 1253

### Molecular Weights, Molecular Weight Distribution, Mn, Mw, MWD

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} x {M}_{i} )}{{\sum }_{i = 1}^{N} {A}_{i}} \qquad ( 2 )$$

$${M}_{Z} = \frac{{\sum }_{i = 1}^{N} ( {A}_{i} x {M}_{i}^{2} )}{{\sum }_{i = 1}^{N} ( {A}_{i} x {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3×Agilent-PLgel Olexis and 1×Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g ,$$

$${α}_{PS} = 0 \text{.655}$$

$${K}_{PE} = 39 \times {10}^{- 3} mL / g ,$$

$${α}_{PE} = 0.725$$

A third order polynomial fit was used to fit the calibration data.

All samples were prepared in the concentration range of 0.5-1 mg/ml and dissolved at 160° C. for 3 hours for PE under continuous gentle shaking.

### Determination of the Chemical Heterogeneity by Cross Fractionation Chromatography (CFC)

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four-band IR5 infrared detector (PolymerChar, Valencia, Spain) was used to monitor the concentration. Around 40 mg of the polymer sample was dissolved in 25 ml TCB in the stainless steel vessel for 150 min at 150° C. Once the sample was completely dissolved an aliquot of 0.5 ml was loaded into the TREF column and stabilized for 60 minutes at 110° C. The polymer was crystallized and precipitate to a temperature of 30° C. by applying a constant cooling rate of 0.1° C./min. A discontinuous elution process is performed using the following temperature steps: (35, 40, 45, 50, 53, 56, 59, 62, 64, 66, 69, 72, 76, 79, 82, 85, 89, 91, 93, 95, 97, 100, 110, and 120) In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PE molecular weight equivalents.

$${K}_{PS} = 19 \times {10}^{- 3} mL / g ,$$

$${α}_{PS} = 0 \text{.655}$$

$${K}_{PE} = 39 \times {10}^{- 3} mL / g ,$$

$${α}_{PE} = 0.725$$

A third order polynomial fit was used to fit the calibration data. Data processing was performed using the software provided from PolymerChar with the CFC instrument.

### Soluble Fraction SF@35° C.

The soluble fraction@35° C. is simply the polymer fraction eluting at 35° C. in CFC.

### Mw(Tp(LCF)/Mw(Tp(HCF) and Ratio of Half Peak Breadth Tp(LCF)/Tp(HCF)

To determine the weight average molecular weight at the peak maximum of the low crystalline fraction (Mw(Tp(LCF)), or of the high crystalline fraction (Mw(Tp(HCF)) and of the half peak breadth of Tp(LCF) and Tp (HCF) in a first step an a-TREF curve is retrieved from the CFC analysis, described above.

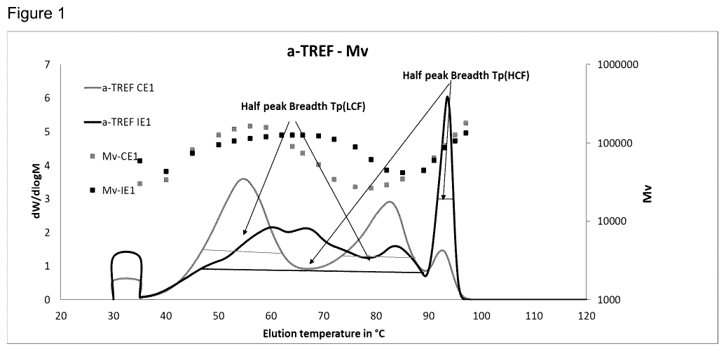

From the a-TREF curve the peak maximum of the high crystalline fraction (HCF) peak (Tp(HCF)) and of the low crystalline fraction (LCF) peak (Tp(LCF) are determined. The elution temperature of the Tp(HCF) is higher than Tp(LCF) and smaller than 99° C. Normally the high crystalline fraction is ranging from 90° C. to 99° C. and the low crystalline fraction is the polymer fraction eluting from 35 to 90° C. In FIG. 1 the a-TREF obtained from CFC analysis of IE1 and CE1 are shown.

The half peak breadth of both HCF and LCF are defined as the elution temperature difference between the front temperature and the rear temperature at the half of the maximum peak height of Tp(LCF) or Tp(HCF) respectively. The correspondent front temperature was searched forward from 35° C., while the rear temperature at the half of the maximum was searched backwards from 100° C., if the peaks are not well separated. If the LCF is well separated from HCF then the rear temperature was searched after the HCF.

In the next step the Mw at the elution temperature of Tp(LCF) and Tp(HCF) were determined. Therefore the Mw at the Tp(LCF) (Mw(Tp(LCF)) was calculated by a linear interpolation between the measured Mw values by GPC of the elution temperatures which was above the Tp(LCF) and below Tp (LCF). This was achieved by using e.g. “TREND” function in Excel. The same procedure was done to determine the Mw at Tp(HCF). From the determined Mw(Tp(LCF), Mw(Tp(HCF), the half peak breadth (LCF) and half peak bredath (HCF) and the Tp(LCF) the following parameters can be calculated straight forward:
Mw (Tp(LCF)/Mw(Tp(HCF)
Half peak breadth Tp(LCF)/Tp(HCF)

### Tensile Modulus

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Instrumented Puncture Impact (IPT)

The instrumented puncture impact was determined by the Free-Falling Dart Method (ISO 7765-Part 2).Maximum force, deflection at maximum force, energy to maximum force, puncture deflection and puncture energy were determined in the instrumented puncture impact behaviour test according to ISO 7765-2. The films were blown with a thickness of 40 microns. The testing conditions used were: impact velocity of 4.4 m/s (or another), with 20 mm diameter not lubricated striker, at 23±2° C. (or at another temperature always ±2° C.). The specimens were clamped with a support ring of 40 mm diameter.

### Critical Shear Rate (CSR)

Determination of the beginning of flow instabilities at high shear rates was determined by using a RHEOGRAPH 75 high-pressure capillary rheometers (GÖTTFERT) according to ISO 11443 at 190° C. Capillary L/D: 30/2.

### Film Sample Preparation

The monolayer test films consisting of the inventive multimodal copolymer (P) and respective comparative polymer of 40 μm thickness, were prepared using a W&H semi-commercial line. Film samples were produced with BUR 1:3. Melt temperature ˜222° C. and frost line distance 700 mm, screw speed 94 rpm and take off speed 18.8 m/min.

### Experimental Part

### Cat.Example: Catalyst Preparation for Inventive Examples (CAT1)

### Loading of SiO2:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis {2-(5-(trimethylsilyl) furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Catalyst for Comparative Examples (CAT2)

As catalyst CAT2 an alumoxane containing, supported catalyst containing metallocene bis (1-methyl-3-n-butylcyclopentadienyl) zirconium (IV) chloride and with enhanced ActivCat® activator technology from Grace was used.

### Polymerization: Inventive Examples: Inventive Multimodal Polyethylene Copolymer (P) With 1-butene and 1-hexene Comonomers (IE1) and Comparative Example (CE1)

Borstar pilot plant with a 3-reactor set-up (loop1-loop2-GPR 1) and a prepolymerization loop reactor.

The inventive multimodal copolymers (P) of example 1 (IE1) as well as of the comparative example (CE1) were produced by using the polymerization conditions as given in Table 1.

TABLE 1
Polymerization conditions

| | IE1 | CE1 |
|---|---|---|
| Prepoly reactor | | |
| Catalyst | CAT1 | CAT2 |
| Catalyst feed (g/h) | 29.9 | 17.0 |
| Temp. (° C.) | 50 | 50.0 |
| Press. (kPa) | 5614 | 5692.4 |
| C2 (kg/h) | 4.0 | 4.0 |
| H2(g/h) | 0.03 | 0.0 |
| C4 (g/h) | 93.1 | 176.3 |
| Split (wt %) | 3.6 | 2.7 |
| loop 1 Fraction (A-1) | | |
| Temp. (° C.) | 85 | 85 |
| Press. (kPa) | 5536 | 5525.5 |
| C2 conc. (mol %) | 4.3 | 3.5 |
| H2/C2 ratio (mol/kmol) | 1.34 | 0.1 |
| C4/C2 ratio (mol/kmol) | 88.0 | 33.6 |
| Split (wt %) | 18.2 | 15.6 |
| Density (kg/m3) of loop 1 material (fraction (A-1)) | 938.3 | 940 |
| MFR2 (g/10 min) of loop 1 material (fraction (A-1)) | 120.0 | 0.8 |
| loop 2 | | |
| Temp. (° C.) | 85 | 85.0 |
| Press. (kPa) | 5350 | 5333.4 |
| C2 conc. (mol %) | 4.3 | 2.7 |
| H2/C2 ratio (mol/kmol) | 0.85 | 0.3 |
| C4/C2 ratio (mol/kmol) | 62.1 | 201.5 |
| Split (wt %) | 20.2 | 18.9 |
| Density (kg/m3) after loop 2 (component (A)) | 941.3 | 942.0 |
| MFR2 (g/10 min) after loop 2 (component (A)) | 122 | 6.3 |
| MFR2 (g/10 min) of loop 2 material (fraction (A-2)) | 124.2 | 45 |
| Density (kg/m3) of loop 2 material (fraction (A-2)) | 944.5 | 944 |
| C4 (mol %) after loop 2 material (Component (A)) | 1.43 | 0.54 |
| GPR | | |
| Temp. (° C.) | 75 | 75.0 |
| Press. (kPa) | 2000 | 2000.0 |
| H2/C2 ratio (mol/kmol) | 0.77 | 0.2 |
| C6/C2 ratio (mol/kmol) | 10.06 | 30.3 |
| Split (wt %) | 58.1 | 62.8 |
| MFR2 (g/10 min) of GPR material (Component (B)) | 0.01 | 0.3 |
| Density (kg/m3) of GPR material (Component (B)) | 898.9 | 902 |
| C6 (mol %) of GPR material Component (B)) | 4.99 | 4.62 |

The polymer of CE1 was mixed with 2400 ppm of Irganox B561, 270 ppm of Dynamar FX 5922, compounded and extruded under nitrogen atmosphere to pellets by using a twin screw extruder ZSK18; melt temperature 192° C.

The polymer of IE1 was mixed with only 2400 ppm of Irganox B561, compounded and extruded under nitrogen atmosphere to pellets by using a twin screw extruder ZSK18; melt temperature 192° C.

TABLE 2
Material properties of inventive multimodal copolymer (P)
and comparative copolymer, as well as film parameters

| Material | IE1 | CE1 |
|---|---|---|
| MFR₂ (g/10 min) (final) | 0.63 | 0.99 |
| Density (kg/m³) | 916.7 | 916.6 |
| C4 (mol %) | 0.6 | 0.2 |
| C6 (mol %) | 2.9 | 2.9 |
| Mn (g/mol) | 16000 | 25000 |
| Mw (g/mol) | 103000 | 105000 |
| Mw/Mn | 6.5 | 4.2 |
| Mw(Tp(LCF)/Mw(Tp(HCF)* | 4.96 | 1.3 |
| Ratio Half peak breadth Tp(LCF)/ Half peak | 1.1 | 19.5 |
| breadth Tp(HCF)* | | |
| SF@35° C./density_{P} | 0.003 | 0.007 |
| CSR (s⁻¹) | 1008 | 130 |
| Film Properties | | |
| IPT (J/mm) | 130 | 106 |
| Tensile Modulus MPa (MD/TD) | 192/220 | 180/206 |

*HCF: High crystalline fraction/LCF: Low crystalline fraction.
CFC data.

From the above table it can be clearly seen, that films consisting of the inventive multimodal copolymer (P) show a higher impact strength in IPT and Tensile Modulus compared to the comparative example.

Furthermore, such films can be processed with clearly higher critical shear rate.

The inventive polymer additionally has a beneficial low SF@35° C./density_{P}.

Claims

1

-

15

. (canceled)

16. A metallocene-catalysed multimodal polyethylene copolymer (P), which consists of:
(i) 35.0 to 50.0 wt % of an ethylene-1-butene polymer component (A), and
(ii) 50.0 to 65.0 wt % of an ethylene-1-hexene polymer component (B),
whereby the ethylene-1-butene polymer component (A) has:
a density in a range of from 930 to 960 kg/m³,
an MFR₂ (190° C., 2.16 kg, ISO 1133) in a range of from 30.0 to 300.0 g/10 min,
a 1-butene content in a range of 0.1 to 3.0 mol %, based on the ethylene-1-butene polymer component (A);
wherein the ethylene-1-butene polymer component (A) consists of an ethylene-1-butene polymer fraction (A-1) and an ethylene-1-butene polymer fraction (A-2),
whereby the ethylene-1-hexene polymer component (B) has:
a density in a range of from 880 to 920 kg/m³,
an MFR₂ (190° C., 2.16 kg, ISO 1133) in a range of from 0.001 to 1.0 g/10 min,
a 1-hexene content in a range of 2.5 to 10.0 mol % based on the ethylene-1-hexene polymer compound (B);
whereby the multimodal polyethylene copolymer (P) has:
a density in a range of from 910 to 945 kg/m³,
an MFR₂ (190° C., 2.16 kg, ISO 1133) in a range of from 0.1 to 3.0 g/10 min,
a ratio of a molecular weight (Mw) of a low crystalline fraction (LCF) to a molecular weight (Mw) of a high crystalline fraction (HCF), Mw(Tp(LCF)/Mw(Tp(HCF), determined as described in an experimental part, in a range of from 2.5 to 10.0,
a ratio of a breadth at Half peak height Tp(LCF)/to a breadth at Half peak height Tp (HCF) in a range of from 0.9-5.9, and
a ratio of a soluble fraction at 35° C. determined with cross-fractionation chromatography (CFC) as described in an experimental part to the density of the multimodal polyethylene copolymer (P), SF@35° C./densityP of below 0.007.

17. The metallocene-catalysed multimodal polyethylene copolymer (P) according to claim 16,
wherein a density of fractions (A-1) and (A-2) is in a range of from 925 to 960 kg/m³ and the MFR₂ (190° C., 2.16 kg, ISO 1133) is in a range of from 30 to 300 g/10 min and wherein the density and/or the MFR2 (190° C., 2.16 kg, ISO 1133) of ethylene polymer fractions (A-1) and (A-2) is the same or is different.

18. The metallocene-catalysed multimodal copolymer (P) according to claim 16, wherein the ethylene polymer component (A) has an MFR2 (190° C., 2.16 kg, ISO 1133) of 35.0 to 250.0 g/10 min, and/or of 40.0 to 200.0 g/10 min, and/or of 45 to 150.0 g/10 min, and
the ethylene polymer component (B) has an MFR2 (190° C., 2.16 kg, ISO 1133) 0.005 to 0.9 g/10 min, and/or of 0.008 to 0.7 g/10 min, and/or of 0.01 to 0.5 g/10 min.

19. The metallocene-catalysed multimodal copolymer (P) according to claim 16, wherein a total amount of 1-butene, based on the multimodal polymer (P) is in a range of from 0.1 to 1.0 mol %, and/or 0.2 to 0.8 mol %, and/or 0.3 to 0.7 mol %, and/or
a total amount of 1-hexene, based on the multimodal polymer (P) is in a range of 1.5 to 8.0 mol %, and/or 2.0 to 6.0 mol %, and/or 2.2 to 4.0 mol %.

20. The metallocene-catalysed multimodal copolymer (P) according to claim 16, wherein a total amount (mol %) of 1-butene, present in the ethylene-1-butene polymer component (A) is in a range of 0.5 to 2.6 mol %, and/or of 0.8 to 2.0 mol %, and/or of 1.0 to 1.8 mol %, based on the ethylene-1-butene polymer component (A), and
a total amount of 1-hexene, present in the ethylene-1-hexene polymer component (B) is in a range of 3.0 to 8.0 mol %, and/or of 3.5 to 6.0 mol %, based on the ethylene-1-hexene polymer component (B).

21. The metallocene-catalysed multimodal copolymer (P) according to claim 16, wherein the ethylene polymer component (A) is present in an amount of 35.0 to 50.0 wt % based on the multimodal copolymer (P), and/or in an amount of 36.0 to 48.0 wt %, and and/or in an amount of 38.0 to 45.0 wt %, based on the multimodal copolymer (P), and
the ethylene polymer component (B) is present in an amount of 50.0 to 65.0 wt % based on the multimodal copolymer (P), and/or in an amount of 52.0 to 64.0 wt %, and/or in an amount of 55.0 to 62.0 wt %, based on the multimodal copolymer (P).

22. The metallocene-catalysed multimodal copolymer (P) according to claim 16, wherein the multimodal copolymer (P) is produced in a presence of metallocene complex of formula (I): 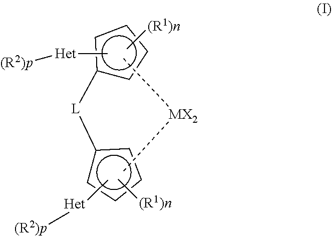
wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

23. The metallocene-catalysed multimodal copolymer (P) according to claim 16, wherein the multimodal copolymer (P) has an improved processability expressed by a critical shear rate (CSR) determined according to ISO 11443 of at least 200 s⁻¹, and/or of at least 500 s⁻¹, and/or of at least 800 s⁻¹ up to 1500 s⁻¹, and/or up to 1300 s⁻¹.

24. The metallocene-catalysed multimodal copolymer (P) according to claim 16, wherein the multimodal copolymer (P) has a ratio of the molecular weight (Mw) of the low crystalline fraction (LCF) to the molecular weight (Mw) of the high crystalline fraction (HCF), Mw(Tp(LCF)/Mw(Tp(HCF), determined as described in an experimental part, in a range of 3.0 to 8.0, and/or of 3.5 to 6.5, and/or
a ratio of the breadth at Half peak height Tp (LCF)/to the breadth at Half peak height Tp (HCF) in a range of from 0.9 to 4.0, and/or 1.0 to 2.0.

25. The metallocene-catalysed multimodal copolymer (P) according to claim 16, wherein the multimodal copolymer (P) has a ratio of the soluble fraction at 35° C. determined with cross-fractionation chromatography (CFC) as described in an experimental part to the density of the multimodal polyethylene copolymer (P), SF@35° C./densityp below 0.006, and/or below 0.005, and/or in a range of 0.001 to below 0.006, and/or 0.001 to below 0.005.

26. Film comprising a metallocene-catalysed multimodal copolymer (P) according to claim 16.

27. Film according to claim 26, wherein the film comprises:
at least one layer containing the metallocene-catalysed multimodal copolymer (P), whereby the at least one layer includes at least 50 wt %, and/or at least 60 wt %, and/or at least 70 wt %, an/or at least 80 wt %, of the metallocene catalysed multimodal copolymer (P).

28. Film according to claim 26, wherein the film is an impact strength in the Instrumented Puncture Test (IPT) determined according to ISO 7765-2 on a 40 μm monolayer test blown film of at least 110 J/mm to 300 J/mm, and/or 115 J/mm to 250 J/mm, and/or 120 J/mm to 200 J/mm.

29. Film according to claim 26, wherein the film is a tensile modulus (measured on a 40 μm monolayer test blown film according to ISO 527-3) in machine (MD) as well as in transverse (TD) direction in a range of from >160 MPa to 350 MPa, and/or of from 180 MPa to 300 MPa.

30. Film according to claim 26, in combination as a packing material for food and/or medical products.
